(19) United States
(12) Patent Application Publication
(10) Pub. No.: US 2006/0170879 A1
(43) Pub. Date: Aug. 3, 2006

(54) Rear projector

(75) Inventors: Shigeki Kato, Chino (JP); Toshihiko Nagumo, Shiojiri (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/338,725

(22) Filed: Jan. 25, 2006

(30) Foreign Application Priority Data
Jan. 28, 2005 (JP) 2005-021780

(51) Int. Cl. G03B 21/28

(52) U.S. Cl. 353/77

(57) ABSTRACT

A rear projector, includes: a light source; an optical modulator that forms images through modulation of luminous fluxes coming from the light source based on image information; an image formation device provided with a projection optical device that enlarges and projects the images formed by the optical modulator; a reflective mirror that reflects the luminous fluxes as the images coming from the projection optical device; a screen on which the luminous fluxes are projected after reflected by the reflective mirror; and a box cabinet that accommodates the components of the rear projector. In the rear projector, the cabinet includes a first cabinet section that accommodates the image formation device, and a second cabinet section that is provided with the screen and the reflective mirror, the optical modulator is accommodated in a sealed space including a space of the second cabinet section, the second cabinet section includes a side surface on which the screen is provided, and another side surface that faces the side surface and is placed with an interstice from the reflective mirror, and the interstice is formed with a path through which air used for cooling the optical modulator circulates.

### CROSS-REFERENCE TO RELATED APPLICATION

The present application claims priority to Japanese Patent Application No. 2005-021780 filed Jan. 28, 2005, which is hereby expressly incorporated by reference herein in its entirety.

### BACKGROUND

1. Technical Field

The present invention relates to a rear projector that includes: a light source; an optical modulator that forms images through modulation of luminous fluxes coming from the light source based on image information; an image formation device provided with a projection optical device that enlarges and projects the images formed by the optical modulator; a reflective mirror that reflects the luminous fluxes, i.e., the images, coming from the projection optical device; a screen on which the luminous fluxes are projected after reflected by the reflective mirror; and a box cabinet that accommodates these components of the rear projector.

2. Related Art

Projectors are recently becoming popular for use for home theaters or others. Such projectors include a rear projector of a type that projects images onto a screen from the rear side to make the images viewable for users on the front side. The rear projector of such a type is configured to include: a light source; an optical modulation device exemplified by a liquid crystal panel that forms images through modulation of luminous fluxes coming from the light source based on image information; a projection lens that enlarges and projects the formed images; a reflective mirror that reflects the luminous fluxes, i.e., the projection images, coming from the projection lens; a light-transmissive screen on which the images are projected after reflected by the reflective mirror; and a cabinet that accommodates the components of the rear projector.

The issue here is that, when such a rear projector is driven, components of a light source unit, an optical modulator, or others for use for image formation are all increased in temperature. These components are often made sensitive to heat, and thus there needs to cool those components with a high degree of efficiency to drive stably the rear projector.

For cooling the components, another concern rises over dust attachment on the optical modulator, the screen, or others if the components in the cabinet of the rear projector are cooled by air coming from the outside of the cabinet. If this is the case, the attached dust or others problematically appear shaded in the projection images so that the images on a display are to be degraded.

For solution of such problems, a rear projector is known for the type that components such as an optical modulator and a screen are accommodated together in the space sealed to be airtight, and air is circulated in the sealed space so that the optical modulator is cooled. As an exemplary rear projector of such a type, refer to Patent Document 1 (JP-A-2003-270720, Pages 7 and 8, and FIGS. 5 and 6).

The rear projector of Patent Document 1 has the substantially-T-shaped sealed space in the cabinet, and the sealed space is made up of upper and lower spaces. The lower space carries therein an electro-optical device, a circulation fan, and a duct. The electro-optical device includes a liquid crystal panel or others serving as an optical modulator. The circulation fan is placed below the electro-optical device, and the duct is covering the electro-optical device. In the sealed space, the air ejected from the circulation fan is directed to the electro-optical device for cooling the device, and is then flown into the upper space, i.e., at the left end, through the duct. In the upper space, the air used for cooling the electro-optical device as such is flown into the right end as if forced, and is then sucked by the circulation fan in the lower space. Such air circulation in the sealed space eliminates the need to guide the air into the cabinet from the outside to cool the electro-optical device so that no dust enters any more. As a result, the liquid crystal panel can be cooled efficiently, and images can be protected from degradation.

With such a rear projector as found in Patent Document 1, however, image flickering may occur. This is because the air may flow across the front side of the reflective mirror provided in the upper space on the way from the left to right end in the upper space. That is, the flow path for the air heated after used for cooling the electro-optical device goes across the optical path for luminous fluxes, i.e., images, from the projection optical device to the screen via the reflective mirror so that light scattering may occur. With this being the case, this raises a problem of degrading the images to be projected on the screen.

### SUMMARY

An advantage of some aspects of the invention is to provide a rear projector capable of preventing image degradation, and cooling any objects in a sealed space in a preferable manner.

An aspect of the invention is directed to a rear projector that includes: a light source; an optical modulator that forms images through modulation of luminous fluxes coming from the light source based on image information; an image formation device provided with a projection optical device that enlarges and projects the images formed by the optical modulator; a reflective mirror that reflects the luminous fluxes, i.e., the images, coming from the projection optical device; a screen on which the luminous fluxes are projected after reflected by the reflective mirror; and a box cabinet that accommodates the components of the rear projector. The cabinet includes a first cabinet section that accommodates the image formation device, and a second cabinet section that is provided with the screen and the reflective mirror. The optical modulator is accommodated in the sealed space including the space of the second cabinet section. The second cabinet section includes a side surface on which the screen is provided, and the other surface that faces the side surface on which the screen is provided surface and is placed with an interstice from the reflective mirror. The interstice is formed with a path through which air used for cooling the optical modulator circulates.

According to the aspect of the invention, the reflective mirror is attached, with an interstice, to the other side surface of the second cabinet section configuring the cabinet. The interstice between the other side surface and the reflective mirror serves as a path for the air circulated in the sealed space for cooling the optical modulator. With such a configuration, the air heated after cooling the optical modulator flows between the reflective mirror and the other side surface so that the path for the heated air does not go across the optical path for the luminous fluxes, i.e., the images, to be projected on the screen from the image formation device via the reflective mirror.

In the cabinet of the rear projector, the reflective mirror is of a large size compared with other components, and such a configuration allows the path to be long for the air after cooling the optical modulator flowing between the reflective mirror and the other side surface of the cabinet keeping hold of the reflective mirror. With such a configuration, the air heated in the course of air flowing can be cooled with good effects.

That is more, the air for use for cooling the optical modulator is so guided as to flow in the sealed space so that no dust or the like enters from the outside of the cabinet.

Accordingly, this prevents image flickering or image degradation due to dust or the like, and can keep the air temperature low in the sealed space so that the components of the rear projector, e.g., optical modulator, can be cooled with better efficiency.

In the aspect of the invention, it is preferable to include a first duct that opens toward the optical modulator at one end, opens toward the interstice at the other end, and guides the air used for cooling the optical modulator toward the interstice.

According to the aspect of the invention, by including the first duct for connection between the optical modulator and the interstice formed between the reflective mirror and the other side surface, the air used for cooling the optical modulator can be flown with good efficiency into the interstice formed between the reflective mirror and the other side surface. This thus can prevent the air from scattering in the sealed space after the air is used for cooling the optical modulator, and prevent the heated air from stopping its flow in the sealed space.

As such, the air can circulate well in the sealed space, and the temperature in the sealed space can be reduced so that the cooling efficiency can be improved for the optical modulator.

In the aspect of the invention, it is preferable to include a first circulation fan below to the projection optical device to circulate the air in the sealed space, and a second duct that is opened toward the air ejection surface of the first circulation fan at one end, is opened toward the optical modulator at the other end, and guides the air ejected from the first circulation fan to the optical modulator.

According to the aspect of the invention, by providing the second duct for connection between the air ejection surface of the first circulation fan located at the lower portion of the projection optical device, and the lower part of the optical modulator, the air ejected from the first circulation fan can be directed directly to the optical modulator through the second duct. Accordingly, the air can be directed to the optical modulator with good efficiency so that the cooling efficiency can be improved in the optical modulator.

In the aspect of the invention, it is preferable that the image formation device includes an optical conversion device that subjects any incoming luminous fluxes to optical conversion, and an optical component cabinet that is set with an illumination optical axis for the luminous fluxes coming from the light source, and is placed at the predetermined position on the illumination axis while accommodating the optical modulation device. The optical component cabinet is formed with apertures at positions each corresponding to the optical conversion devices on the side surfaces facing each other to link inside and outside of the optical component cabinet. One of the apertures is provided with a third duct that links inside of the optical component cabinet and the sealed space to guide the air in the sealed space to the optical conversion device through this aperture, and the other of the apertures is provided with a second circulation fan whose air intake surface is facing the optical conversion devices to circulate the air in the sealed space.

Herein, the optical conversion device is exemplified by a polarizing beam splitter that is provided with a polarizing beam splitter prism and a phase difference film, and aligns the polarization direction of any incoming luminous fluxes, an optical filter device that reduces the transmission of the luminous fluxes of a predetermined wavelength spectrum, or others.

According to the aspect of the invention, the optical component cabinet for accommodating the optical conversion devices is formed with apertures at positions each corresponding to the optical conversion devices on the side surfaces facing each other to link inside and outside of the optical component cabinet. One of the apertures is provided with a third duct that links inside of the optical component cabinet and the sealed space to guide the air in the sealed space to the optical conversion devices through this aperture. The other of the apertures is provided with a second circulation fan whose air intake surface is facing the optical conversion devices to circulate the air in the sealed space. With such a configuration, the sealed space can be formed with the path for cooling the optical conversion devices separately from the above-described path for cooling the optical conversion devices.

More specifically, when the second circulation fan is driven, the air comes from the sealed space through the third duct and gathers and flows closer to the optical conversion devices so that the optical conversion devices are cooled. The air thus used for such cooling is sucked by the second circulation fan, and then is ejected into the sealed space again for air circulation therein. Accordingly, the air in the sealed space can be directed to the optical conversion devices with good efficiency, and the optical conversion devices can be cooled with effect through air circulation in the sealed space.

### BRIEF DESCRIPTION OF THE DRAWINGS

The invention will be described with reference to the accompanying drawings, wherein like numbers reference like elements.

FIG. 1 is a perspective view of a rear projector according to a first embodiment of the present invention viewed from the front;

FIG. 2 is a perspective view of the rear projector of the first embodiment viewed from the rear;

FIG. 3 is a side view of the rear projector of the first embodiment viewed from the left side;

FIG. 4 is a perspective view of an upper cabinet of the first embodiment showing the internal configuration thereof;

FIG. 5 is a perspective view of a lower cabinet of the first embodiment showing the internal configuration thereof;

FIG. 6 is a schematic view of the lower cabinet of the first embodiment showing the internal configuration thereof;

FIG. 7 is a perspective view of an optical unit of the first embodiment;

FIG. 8 is a schematic view of an optical system in the optical unit of the first embodiment;

FIG. 9 is a vertical cross sectional overview of the rear projector of the first embodiment;

FIG. 10 is a vertical cross sectional overview of a rear projector according to a second embodiment of the invention;

FIG. 11 is a schematic view of a cooling path of a polarizing beam splitter of the second embodiment;

FIG. 12 is a plane overview schematically showing a duct of a rear projector according to a third embodiment of the invention; and

FIG. 13 is a schematic view of an electro-optical device and a cooling path of a polarizing beam splitter of the third embodiment.

### DESCRIPTION OF EXEMPLARY EMBODIMENTS

### 1. First Embodiment

In the below, a rear projector according to a first embodiment of the present invention is described by referring to the accompanying drawings.

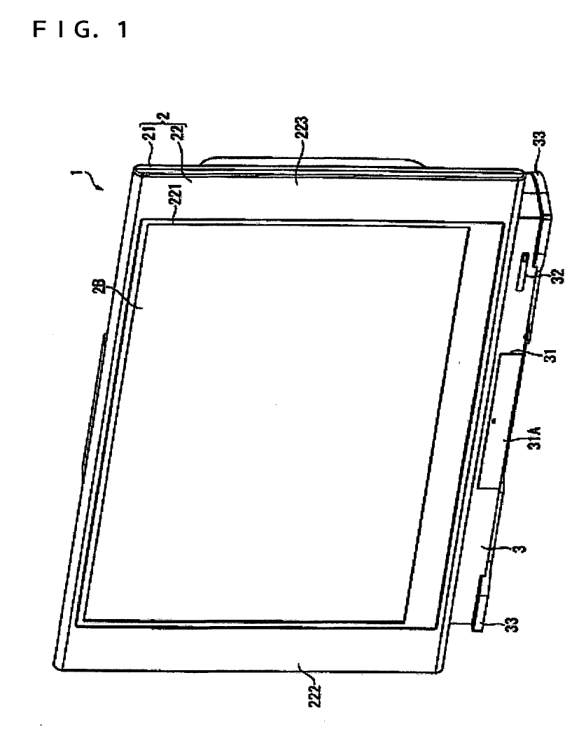

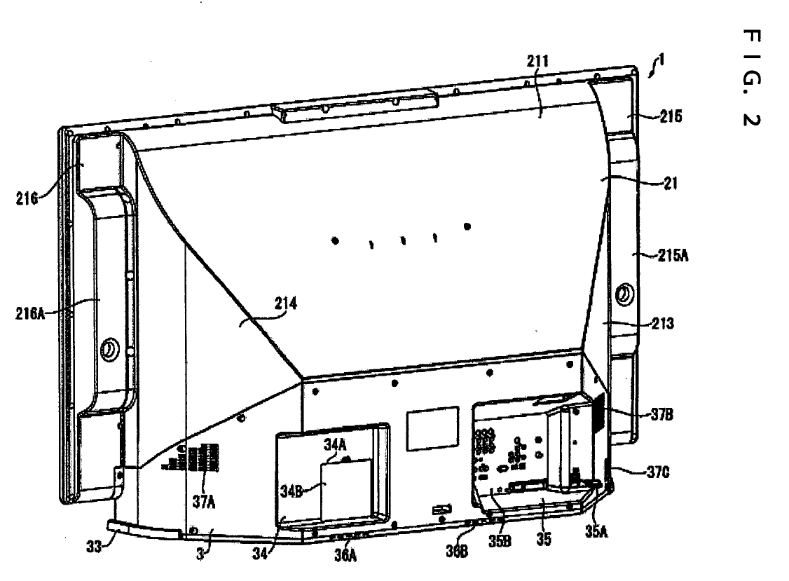

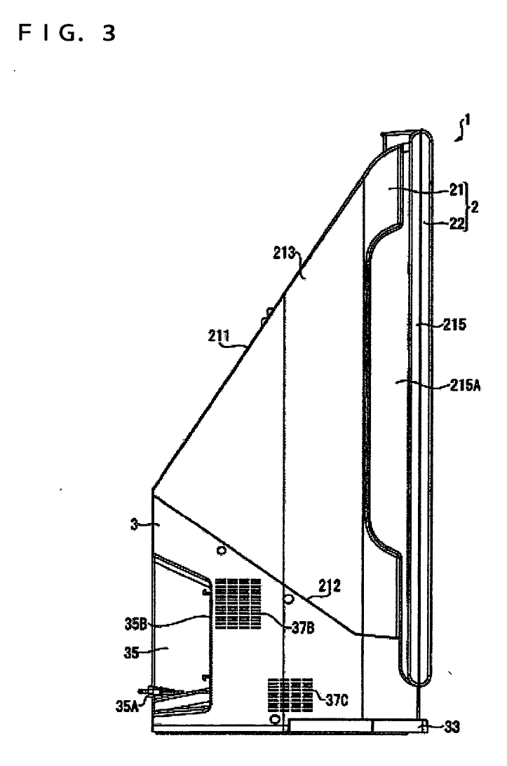

FIG. 1 is a perspective view of a rear projector 1 of the present embodiment viewed from the front. FIG. 2 is a diagram of the rear projector 1 viewed from the rear, and FIG. 3 is a diagram of the rear projector 1 viewed from the left side. Herein, the left side of FIG. 3 means the left when the rear projector 1 is viewed from the front.

The rear projector 1 modulates luminous fluxes coming from a light source based on any incoming image information so that optical images are formed. The resulting optical images are enlarged and projected on a light-transmissive screen 2B provided to the rear projector 1.

a. Outer Configuration

As shown in FIGS. 1 to 3, the rear projector 1 is substantially rectangular in shape viewed from the front, and is configured to include an upper cabinet 2 and a lower cabinet 3. The upper cabinet 2 is of substantially triangular in vertical cross section, and the lower cabinet 3 supports the upper cabinet 2 from below. These upper and lower cabinets 2 and 3 are securely fixed to each other by a screw or others.

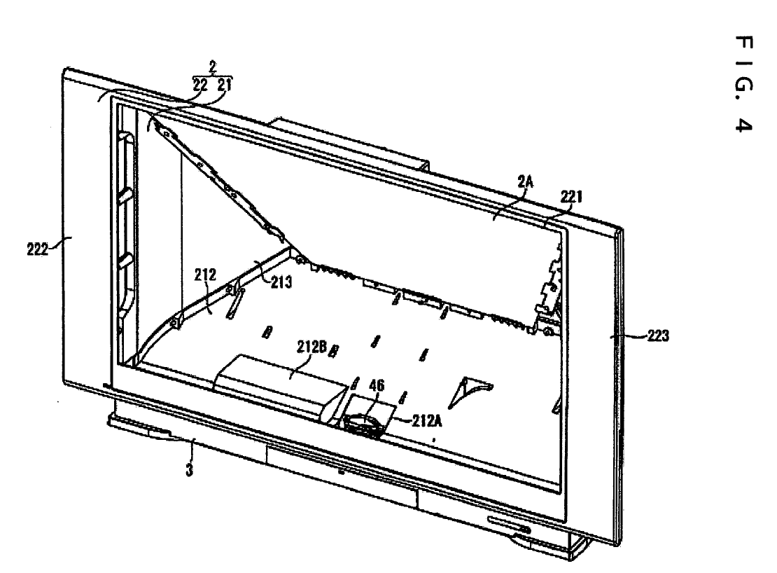

The upper cabinet 2 is equivalent to a second cabinet section of the invention. As shown in FIG. 1, the upper cabinet 2 is configured to include a mirror case 21 that carries therein a reflective mirror 2A (FIG. 4), and a frame 22 for keeping hold of the screen 2B. The reflective mirror 2A will be described later.

The lower cabinet 3 is equivalent to a first cabinet section of the invention, and supports the upper cabinet 2. The lower cabinet 3 is a box cabinet that is of substantially trapezoid when viewed from above, carrying therein main components of the rear projector 1. The plane shape of the lower cabinet 3 is substantially the same as the plane shape of the upper cabinet 2.

a-1. Configuration of Front Side of Rear Projector 1

As shown in FIG. 1, the frame 22 is placed on the front side of the rear projector 1, i.e., on the front side of the upper cabinet 2.

The frame 22 is substantially rectangular in shape when viewed from the front, and is of substantially the same size as the front side of the mirror case 21 (FIG. 2) that will be described later. The frame 22 is securely fixed to the mirror case 21 at the front side by a screw or others.

As described above, the frame 22 keeps hold of the screen 2B onto which optical images are to be projected. For the purpose as such, the frame 22 is formed with, at substantially the center thereof, a substantially-rectangular aperture section 221 of substantially the same size as a region of the screen 2B onto which the optical images are to be projected. From the aperture section 221, the screen 2B exposes. On the right and left sides of the aperture section 221, speaker set-up sections 222 and 223 are formed with two speakers (not shown) on the rear surface side, respectively.

The screen 2B is configured to include a protection plate such as Fresnel sheet, lenticular sheet, glass plate. Specifically, the Fresnel sheet collimates luminous fluxes reflected on the reflective mirror 2A (FIG. 4) after coming from a projection lens 46 of an optical unit 4. The optical unit 4 and the reflective mirror 2A are both left for later description. The lenticular sheet is so configured as to scatter the luminous fluxes collimated by passing through the Fresnel sheet so as to make display images visually identifiable.

The front side of the lower cabinet 3 is formed with, at substantially the center thereof, a substantially-rectangular aperture section 31. The aperture section 31 is closed or opened by a lid member 31 A that pivots in the vertical direction.

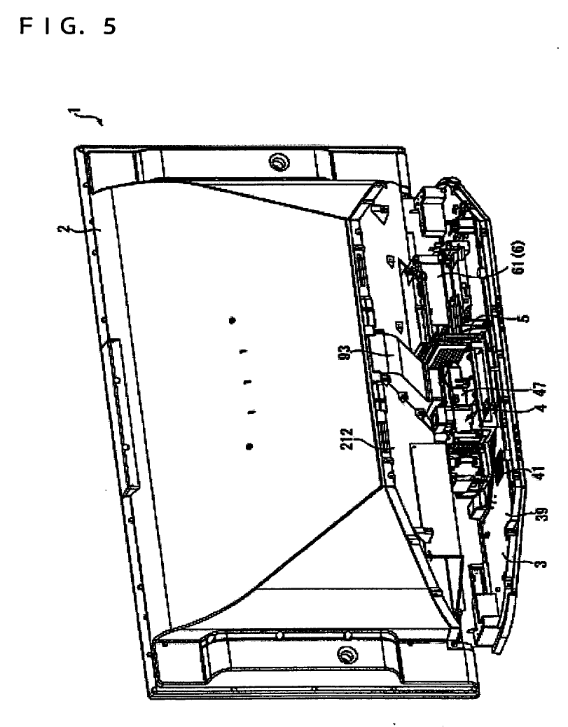

Although not shown in detail, the aperture section 31 is provided therein with a front panel serving as a front-side operation panel. On the left side part of this front panel, various components are placed, i.e., various types of operation switches for volume control, image quality adjustment or the like, a D-Sub terminal serving as a PC (Personal Computer) connection terminal, a stereo audio input terminal, a video input terminal, an S terminal, or others. The right side part of the front panel is formed with an aperture to accept various types of semiconductor memory card. In this aperture, a card reader is provided for data reading from the memory cards. On the right side of the aperture section 31, a power switch 32 is provided. The front panel and the power switch 32 are electrically connected to a control substrate 5 (FIG. 5), which will be described later.

The front side of the lower cabinet 3 is formed with a leg section 33 at right and left ends, respectively.

a-2. Configuration of Rear Side of Rear Projector 1

As shown in FIGS. 2 and 3, the rear side of the rear projector 1 is configured to include the mirror case 21 of the upper cabinet 2, and the lower cabinet 3.

The mirror case 21 is a synthetic-resin-made box cabinet, and is of substantially triangular in vertical cross section. The mirror case 21 is configured by a rear wall 211 serving as the rear surface of the rear projector 1, a bottom wall 212 for connection with the lower end portion of the rear wall 211, and a pair of side walls 213 and 214 located on the right and left sides of the rear wall 211 and the bottom wall 212, respectively. The front side of the mirror case 21 is formed with extension sections 215 and 216, which are extending in the direction substantially orthogonal to the side walls 213 and 214 to be away from each other, i.e., the lateral direction of the rear projector 1.

The rear wall 211 is substantially trapezoid in shape when viewed from above, with the longer side located above. The rear wall 211 is directed downward toward the rear. The inner surface of the rear wall 211 is supporting, at a predetermined angle, the reflective mirror 2A (FIG. 4) that will be described later.

The pair of side walls 213 and 214 are so formed as to connect the right and left ends of the rear wall 211 and the bottom wall 212. The side walls 213 and 214 are both directed inward toward the rear.

The extension sections 215 and 216 are formed larger than the side walls 213 and 214 in the vertical direction, and at their substantially center portions, bulging sections 215A and 216A are respectively formed. The bulging sections 215A and 216A are both bulging in the rear direction, and form a speaker enclosure in combination with the speaker set-up sections 222 and 223 (FIG. 1) of the frame 22.

The rear side of the lower cabinet 3 is formed with a first concave section 34 on the left side of FIG. 2, and with a second concave section 35 on the right side thereof.

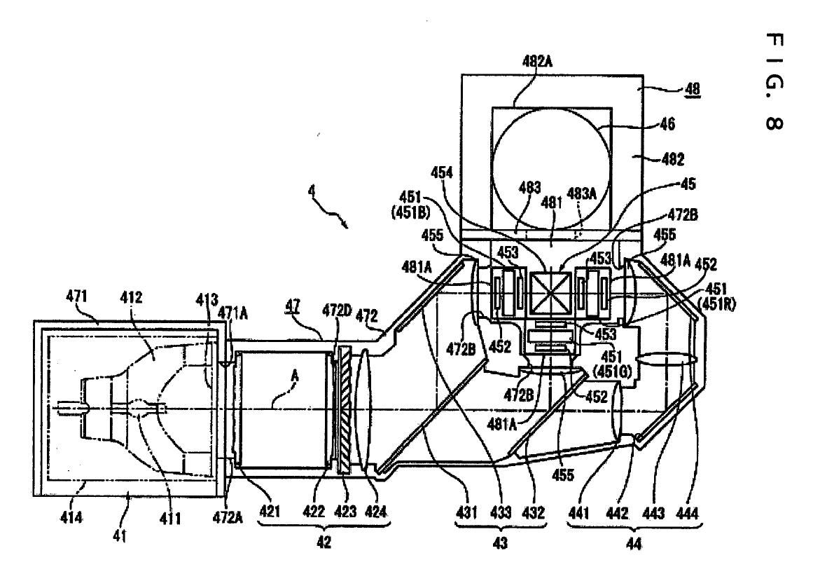

The first concave section 34 is formed with a substantially-square lamp exchange port 34A, which is covered by a lamp cover 34B. This lamp exchange port 34A is opened by removing the lamp cover 34B, and via the lamp exchange port 34A, a light source device 41 of the optical unit 4 (FIGS. 5 and 8) that will be described later can be exchanged.

The second concave section 35 is provided with a power cable 35A, and a rear panel 35B serving as a rear-side operation panel. To the rear panel 35B, various components are placed, i.e., a DVI (Digital Visual Interface) terminal serving as a PC connection terminal, an antenna input terminal, and a video/audio input/output terminal of multi system, and others.

Beneath the first and second concave sections 34 and 35, air intake ports 36 (36A and 36B) are formed for guiding cooling air into the lower cabinet 3 to cool the electrical components therein.

On the left side of the first concave section 34, and on the right side of the second concave section 35, air emission ports 37 (37A, 37B, and 37C) are formed. These air emission ports 37A to 37C are all a slit-shaped aperture from which the air is ejected after cooling the various components in the lower cabinet 3.

b. Internal Configuration

b-1. Internal Configuration of Upper Cabinet 2

FIG. 4 is a diagram showing the internal configuration of the upper cabinet 2. More specifically, FIG. 4 is a perspective view of the rear projector 1 viewed from the front, with the screen 2B removed from the state of FIG. 1.

As shown in FIG. 4, the upper cabinet 2 carries therein the reflective mirror 2A that reflects luminous fluxes, i.e., optical images, coming from the projection lens 46 (FIG. 8) in the optical unit 4 (FIG. 5) that will be described later. The optical unit 4 is the one placed inside of the lower cabinet 3. This reflective mirror 2A is of a general type that is substantially trapezoid in shape when viewed from above, having the substantially the same shape as the rear wall 211 (FIG. 2). The reflective mirror 2A is attached inside of the rear wall 211 (FIG. 2) of the upper cabinet 2 with some tilt, with the longer side located above. The tilt angle of this reflective mirror 2A is set based on the positional relationship between the screen 2B (FIG. 1) attached on the front side, and the video reflection by the projection lens 46 (FIG. 8) of the optical unit 4 (FIG. 5) that will be described later. This reflective mirror 2A is attached with an interstice from the rear wall 211.

The bottom wall 212 of the mirror case 21 is substantially trapezoid in shape when viewed from above, with the longer side located front. As shown in FIGS. 2 and 3, the bottom wall 212 is so formed as to direct upward toward the rear. The bottom wall 212 is connected with the rear wall 211 at the end portion of the rear side, and with the side walls 213 and 234 at right and left end portions thereof.

The bottom wall 212 is formed with a substantially-rectangular notch 212A at substantially the center on the front side, and from the notch 212A, the projection lens 46 (FIG. 8) is exposed in the optical unit 4, which will be described later. The notch 212A is formed, on the left side, with a bulging section 212B that is bulging upward. The bulging section 212B is formed at the position corresponding to a power block 61 (FIG. 5) in a power unit 6 (FIG. 5) that will be described later.

b-2. Internal Configuration of Lower Cabinet 3

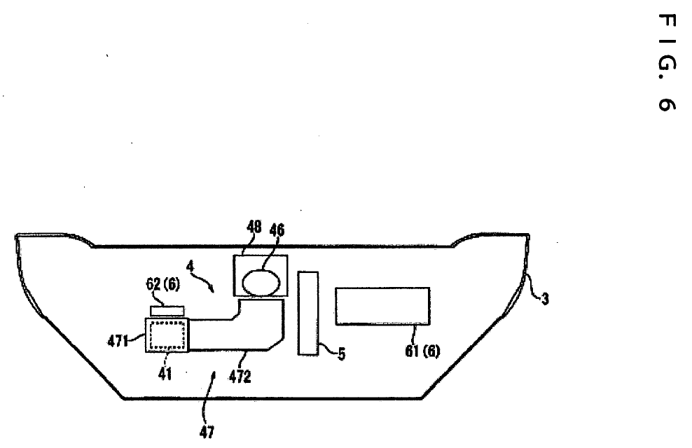

FIG. 5 is a diagram showing the internal configuration of the lower cabinet 3. More in detail, FIG. 5 is a perspective view of the rear projector 1 viewed from the rear, with an exterior case on the rear side of the lower cabinet 3 removed from the state of FIG. 2. FIG. 6 is a plane view schematically showing the internal configuration of the lower cabinet 3.

As shown in FIGS. 5 and 6, the lower cabinet 3 carries therein the optical unit 4 in charge of image formation, the control substrate 5 in charge of drive control over the rear projector 1, the power unit 6 for drive power supply to the electrical components, and others. These components of the optical unit 4, the control substrate 5, and the power unit 6 are placed on a bottom section 39 serving as the bottom surface of the lower cabinet 3. The components accommodated in the lower cabinet 3 as such take charge of main processes such as image formation in the rear projector 1.

Among these components, the optical unit 4 occupies the area in the lower cabinet 3, from the substantially center to the right side, i.e., the optical unit 4 is placed on the left side viewed from the rear. The control substrate 5 and the power unit 6 occupy the area in the lower cabinet 3, from substantially the center to the left side, i.e., the control substrate 5 and the power unit 6 are placed on the area from substantially the center toward the right side viewed from the rear.

c. Configuration of Optical Unit 4

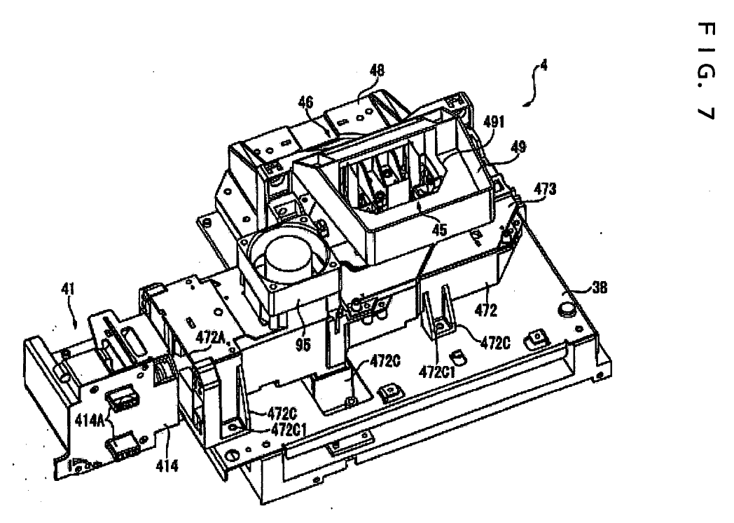

FIG. 7 is a perspective view of the optical unit 4. FIG. 8 is a schematic view of the optical system of the optical unit 4.

The optical unit 4 is equivalent to an image formation device of the invention, and using liquid crystal panels 451, modulates luminous fluxes coming from the light source device 41 based on any incoming image information so that optical images are formed. The resulting optical images are enlarged and projected onto the screen 2B (FIG. 1) using the projection lens 46 via the reflective mirror 2A (FIG. 4). As shown in FIG. 7, this optical unit 4 is placed on an optical unit placement support 38, which is located on the upper surface of the bottom section 39 (FIG. 5) of the lower cabinet.

Note here that this optical unit placement support 38 is made of a plurality of plate members, and is used to securely fix the optical unit 4 to the predetermined position on the bottom section 39.

As shown in FIG. 8, such an optical unit 4 is configured to include the light source device 41, an integrator illumination optical system 42, a color separation optical system 43, a relay optical system 44, an electro-optical device 45, the projection lens 46 serving as the projection optical device, an optical component cabinet 47 for accommodating these components, and a head member 48 for keeping hold of the projection lens 46.

The light source device 41 is configured to include a light source lamp 411 serving as a radiation light source, a reflector 412, an explosion-proof glass 413, and a light source lamp box 414 that is a synthetic-resin-made cabinet for accommodating these components therein. In this light source device 41, radial beams coming from the light source lamp 411 are reflected by the reflector 412 so that the beams become collimated. The resulting collimated beams are emitted toward outside through the explosion-proof glass 413.

The light source lamp 411 is exemplified by a high-pressure mercury lamp in the present embodiment. The high-pressure mercury lamp is surely not the only option, and a metal halide lamp or a halogen lamp will do, for example. The reflector 412 is exemplified herein by a paraboloid mirror. As an alternative option thereto, the combination of a concave collimation lens and an ellipsoidal mirror will do.

The explosion-proof glass 413 is a light-transmissive glass member that closes the aperture section of the reflector 412 in preparation for if the light source lamp 411 explodes. That is, even if explodes, the light source lamp 411 does not scatter outside from the light source lamp box 414 even if it is broken in pieces.

As shown in FIG. 7, the light source lamp box 414 is formed with a pair of handles 414A that are extending toward the rear of the light source device 41 accommodated in the rear projector 1. These handles 414A are provided to easily grasp the light source lamp box 414 at the time of exchange of the light source device 41. If a need arises to exchange the light source device 41 due to the approaching-to-the-end operating life and breakage or others of the light source lamp 411, the above-described lamp cover 34B (FIG. 2) is opened so as to allow entire exchange of the light source device 41 from the lamp exchange port 34A (FIG. 2).

The integrator illumination optical system 42 serves to illuminate three liquid crystal panels 451 almost uniformly at their each image formation region. These three liquid crystal panels 451 configure the electro-optical device 45, and will be described later. As shown in FIG. 8, the integrator illumination optical system 42 is configured to include a first lens array 421, a second lens array 422, a polarizing beam splitter 423, and a superposition lens 424.

The first lens array 412 takes such a configuration that small lenses are arranged in matrix. The small lenses each have a substantially-rectangular contour viewed from the direction of an optical axis, and serve to split a luminous flux coming from the light source device 41 into a plurality of partial luminous fluxes.

The second lens array 422 has substantially the same configuration as the first lens array 421, i.e., taking such a configuration that small lenses are arranged in matrix. This second lens array 422 functions together with the superposition lens 424 to form images of the small lenses of the first lens array 421 on the liquid crystal panels 451.

The polarizing beam splitter 423 is equivalent to an optical conversion device of the invention, and is placed between the second lens array 422 and the superposition lens 424. Such a polarizing beam splitter 423 converts the light coming from the second lens array 422 into a kind, substantially, of linear polarization, and thereby the light use efficiency is increased in the electro-optical device 45.

To be specific, the partial luminous fluxes after converted into substantially a kind of linear polarization by the polarizing beam splitter 423 is nearly superposed on the liquid crystal panels 451 of the electro-optical device 45 eventually by the superposition lens 424. The liquid crystal panels 451 are left for later description. The reason for using the polarizing beam splitter 423 is to increase the light use efficiency in the electro-optical device 45 by converting the luminous fluxes coming from the light source lamp 411 into substantially a kind of linear polarization. This is because with the rear projector 1 using the liquid crystal panel 451 of a type that modulates polarization light, only one type of linear polarization is allowed for use. As a result, even with the light source lamp 411 is capable of emitting various types of random polarization light, only almost half of the light is used in such a rear projector 1.

Note that such a polarizing beam splitter 423 is described in JP-A-8-304739, for example.

The color separation optical system 43 is provided with two dichroic mirrors 431 and 432, and a reflective mirror 433. The color separation optical system 43 has a capability of color separation using the dichroic mirrors 431 and 432. Specifically, the luminous fluxes coming from the integrator illumination optical system 42 are separated into three light colors of red (R), green (G), and blue (B).

The relay optical system 44 is provided with a light-enter-side lens 441, a relay lens 443, and reflective mirrors 442 and 444. By such a relay optical system 41, the red light as a result of color separation in the color separation optical system 43 is guided to a liquid crystal panel 451R provided to the electro-optical device 45 specifically for the red light. The liquid crystal panel 451R will be described later.

As to the luminous fluxes coming from the integrator illumination optical system 42, the dichroic mirror 431 of the color separation optical system 43 transmits the red and green light components but reflects the blue light components. The blue light components thus reflected by the dichroic mirror 431 are reflected again by the reflective mirror 433, and goes through a field lens 455 before reaching a liquid crystal panel 451B of the electro-optical device 45 specifically for the blue light. The liquid crystal panel 451B will be described later. After going through the field lens 455, the partial luminous fluxes coming from the second lens array 422 are collimated with respect to their center axis (chief ray). The field lenses 455 provided on the light-enter side of the optical modulator for the green and red light components work more of the same.

After passing through the dichroic mirror 431, the green light is reflected by the dichroic mirror 432, and then reaches a liquid crystal panel 451G specifically for the green light after going through the field lens 455. The red light, after passing through the dichroic mirror 432, goes through the relay optical system 44 and then the field lens 455 before reaching the liquid crystal panel 451R for the red light.

The reason for using the relay optical system 44 only for the red light is not to reduce the light use efficiency often resulting from light scattering or others due to the longer optical path for the red light compared with that for other color lights, i.e., to pass to the field lens 455 the partial luminous fluxes reaching the light-enter-side lens 441 as they are. Note that the relay optical system 44 is exemplified as transmitting only the red light. This is surely not restrictive, and the blue or green light may be transmitted thereby.

The electro-optical device 45 modulates incoming luminous fluxes based on any image information so that color images are formed, and includes three light-enter-side polarizing plates 452, the three liquid crystal panels 451 as optical modulation devices, three light-exit-side polarizing plates 453, and a cross dichroic prism 454 serving as a color synthesis optical device. Specifically, the light-enter-side polarizing plates 452 receive color lights as a result of color separation by the color separation optical system 43. The liquid crystal panels 451 include the liquid crystal panel 451R for red light, the liquid crystal panel 451G for the green light, and the liquid crystal panel 451B for blue light. These liquid crystal panels 451 are placed in the stage subsequent to each corresponding light-enter-side polarizing plate 452, i.e., subsequent to each corresponding optical path. The light-exit-side polarizing plates 453 are placed in the stage subsequent to each corresponding liquid crystal panel 451, i.e., subsequent to each corresponding optical path. Such components of the light-enter-side polarizing plates 452, the liquid crystal panels 451, the light-exit-side polarizing plates 453, and the cross dichroic prism 454 in the electro-optical device 45 are placed as a unit. Although not specifically shown, the components of the light-enter-side polarizing plates 452, the liquid crystal panels 451, and the light-exit-side polarizing plates 453 are placed with a predetermined space thereamong.

The cooling path of the electro-optical device 45 will be described in detail later.

The light-enter-side polarizing plate 452 receives its corresponding color light that is aligned by the polarizing beam splitter 423 to direct substantially one specific polarization direction. Among thus provided luminous fluxes, the light-enter-side polarizing plate 452 transmits only the polarized light directed to substantially the same direction as the polarization axis of the luminous fluxes aligned by the polarizing beam splitter 423, and absorbs any other luminous fluxes. This light-enter-side polarizing plate 452 takes such a configuration that a light-transmissive substrate made of sapphire glass or quartz crystal is attached thereon with a polarization film, for example.

The liquid crystal panel 451 takes such a configuration that a liquid crystal material, i.e., electro-optical material, is sealed in between a pair of transparent glass substrates. The liquid crystal material in the image formation region is controlled in alignment based on a drive signal coming from the control substrate, which will be described later. Through such control application, the polarized luminous fluxes emitted from the light-enter-side polarizing plate 452 are modulated in polarization direction.

The light-exit-side polarizing plate 453 takes substantially the same configuration as the light-enter-side polarizing plate 452. As to the luminous fluxes coming from the image formation region of the liquid crystal panel 451, the light-exit-side polarizing plate 453 transmits only the luminous fluxes whose polarization axis is orthogonal to the transmission axis of the luminous fluxes for the light-enter-side polarizing plate 452, and absorbs any other luminous fluxes.

The cross dichroic prism 454 is an optical device that forms color images through synthesis of optical images. The optical images are those modulated for every color light coming from the light-exit-side polarizing plates 453. This cross dichroic prism 454 is of square when viewed from above, made of four right-angle prisms attached together. The interfaces of the right-angle prisms are formed with two dielectric multilayer films. The dielectric multilayer films reflect the color lights coming from the liquid crystal panels 451R and 451B through their corresponding light-exit-side polarizing plates 453, and transmits the color lights coming from the liquid crystal panel 451G through its corresponding light-exit-side polarizing plate 453. As such, the color lights modulated by the liquid crystal panels 451R, 451G, and 451B are synthesized together so that color images are formed.

The projection lens 46 is configured to accommodate a plurality of lenses in a barrel, and a mirror for deflecting any incoming luminous fluxes. The projection lens 46 enlarges the color images coming from the electro-optical device 45, and the color images emitted toward the reflective mirror 2A (FIG. 4), i.e., toward the front, are projected toward upward with some angle. As shown in FIG. 8, this projection lens 46 is placed on the light-exit-side of the electro-optical device 45, and is securely fixed to the head member 48 that will be described later. As shown in FIG. 4, the projection lens 46 is placed in the lower cabinet 3 at substantially the center on the front side, and is exposed to inside of the mirror case 21 from the notch 212A formed to the bottom wall 212 of the upper cabinet 2.

As shown in FIG. 8, the optical component cabinet 47 has a predetermined illumination optical axis A therein, which is used as a basis for placement of the above-described optical components 42 to 45 with respect to the illumination optical axis A. As shown in FIGS. 7 and 8, such an optical component cabinet 47 is configured to include a light source device housing member 471, a component housing member 472, and a lid-like member 473.

Although not shown in detail, the light source device housing member 471 is a box that opens toward the rear side with a substantially U-shaped cross section. For placing the light source device 41 in the light source device housing member 471, the light source lamp box 414 is slid toward the front with respect to the light source device housing member 471. For extracting the light source device 41 from the light source device housing member 471, the light source lamp box 414 is slid toward the rear side.

The light source device housing member 471 is connected to the component housing member 472, and at the connection portion therebetween, an aperture section 471A is so formed as to pass through the luminous fluxes coming from the light source lamp 411 of the light source device 41.

The component housing member 472 is a synthetic-resin-made box cabinet with substantially a U-shaped cross section, and is opened upward. As described above, the component housing member 472 is connected with the light source device housing member 471 at one end, and at the other end, is attached with the head member 48 for keeping hold of both the electro-optical device 45 and the projection lens 46. At the end portion of the component housing member 472 on the side connected to the light source device housing member 471, a substantially-rectangular aperture section 472A is so formed that the luminous fluxes coming from the light source device 41 housed in the light source device housing member 471 pass through the component housing member 472.

The component housing member 472 is formed therein with a plurality of grooves, and thereinto, the optical components 421 to 424, 431 to 433, 441 to 444, and 455 are snapped and positioned.

As shown in FIG. 8, in the component housing member 472, notches 472B are so formed as to each serve as an aperture through which the luminous fluxes pass. Such notches 472B are formed on the end surfaces of the U-shaped light-exit-side end portions when viewed from above. From the light-exit-side end portions, the luminous fluxes from the light source lamp 411 of the light source device 41 are emitted and guided inside. For the purpose of sealing and closing the notches 472B, the field lenses 455 are attached at their edge portions.

As shown in FIG. 7, the component housing member 472 is formed with a plurality of leg sections 472C on the outer surface. These leg sections 472C are provided for securely fixing the component housing member 472 to the optical unit placement support 38. The component housing member 472 is then securely screwed into the optical unit placement support 38 through a hole 472C1 that is formed to each of the leg sections 472C.

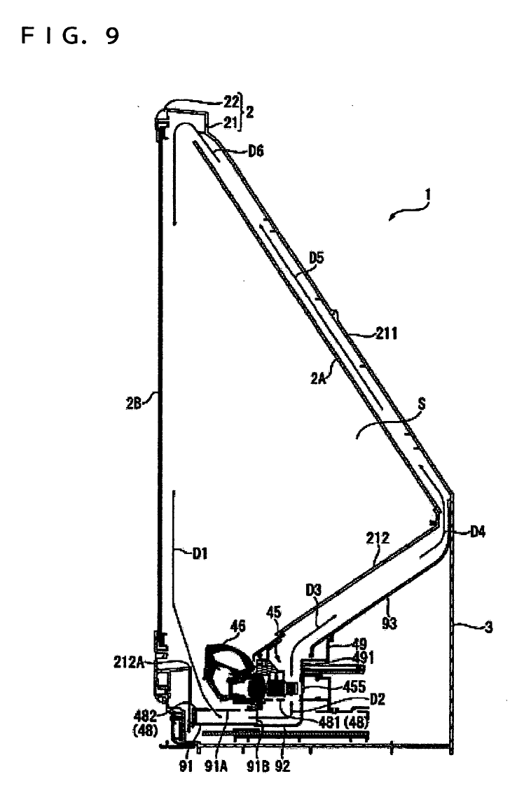

As shown in FIGS. 8 and 9, at the position corresponding to the polarizing beam splitter 423 at the bottom of the component housing member 472, an aperture section 472D is so formed as to link inside and outside of the component housing member 472.

As shown in FIG. 7, the lid-like member 473 is so shaped as to match the plane shape of the component housing member 472, and is of a synthetic-resin-made cabinet to be attached to the component housing member 472 to close the upper opening thereof.

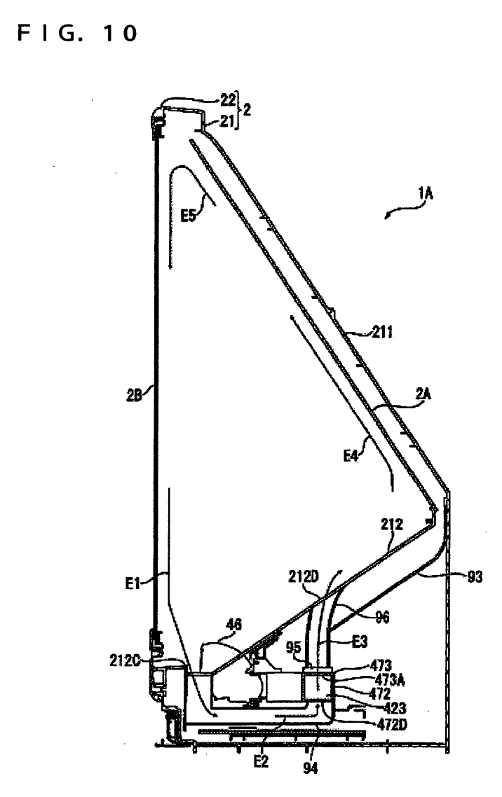

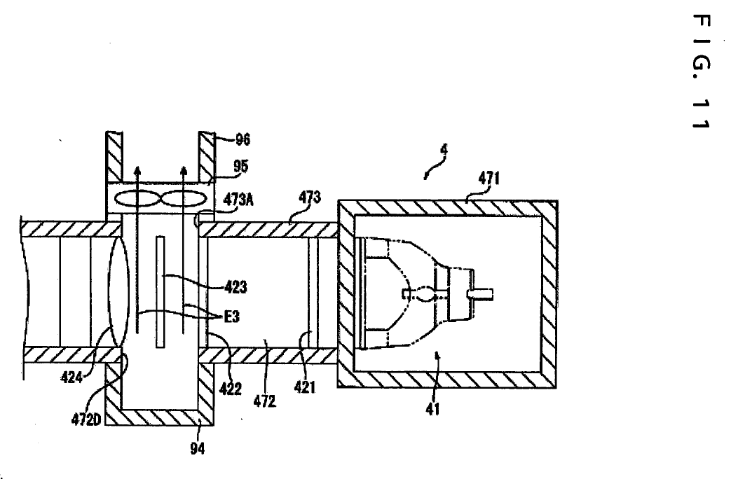

At the position of the lid-like member 473 corresponding to the polarizing beam splitter 423, an aperture section 473A (refer to FIGS. 10 and 11) is formed. In the upper portion of the aperture, a cooling fan 95 is provided to cool the polarizing beam splitter 423 so that the cooled air is supplied to the polarizing beam splitter 423.

At the position of the lid-like member 473 corresponding to the electro-optical device 45, a duct connection member 49 is attached for connection with a duct 93 that will be described later. This duct connection member 49 is substantially rectangular in shape when viewed from above, and is formed at the center with an aperture section 491 for passing the air therethrough used for cooling the electro-optical device 45. A detailed description will be given later about the path for the cooled air going through the duct connection member 49.

As shown in FIG. 8, the head member 48 is attached at the light-exit-side end portion of the component housing member 472 for keeping hold of the projection lens 46.

The head member 48 is made of a metal material such as aluminum alloy or magnesium alloy. The head member 48 is used to combine the electro-optical device 45 and the projection lens 46 as a unit, and to attach the resulting unit to the optical component cabinet 47.

Although not shown in detail, the head member 48 is inverse-T-shaped when viewed from the side, including a horizontal portion 481 on the light-enter side, another horizontal portion 482 on the light-exit side, and a vertical portion 483 that stands vertically from and between the horizontal portions 481 and 482.

The horizontal portion 481 on the light-enter side is securely fixed with the electro-optical device 45, and the horizontal portion 482 on the light-exit side is securely fixed with the projection lens 46. The horizontal portion 481 is formed with three apertures 481A, which all go through the horizontal portion 481 in the vertical direction. These apertures 481A are each formed at the position facing the liquid crystal panel 451, the light-enter-side polarizing plate 452, and the light-exit-side polarizing plate 453, all of which are configuring the electro-optical device 45. The horizontal portion 482 is formed with an aperture section 482A going therethrough at the position corresponding to the lower part of the projection lens 46.

The vertical portion 483 is formed with an aperture section 483A that guides the luminous fluxes coming from the electro-optical device 45 to the projection lens 46.

d. Configuration of Control Substrate 5

The control substrate 5 is longitudinally placed on the left side of the projection lens 46 when the rear projector 1 is viewed from the front, i.e., the right-of-center in FIGS. 5 and 6. The control substrate 5 is entirely covered by a metal shield member formed with a plurality of holes for EMI (Electromagnetic Interference) protection. This control substrate 5 is configured to serve as a circuit board, including a CPU (Central Processing Unit), ROM (Read Only Memory), and RAM (Random Access Memory), and others. The control substrate 5 processes image information received from various connection terminals provided to the front and rear panels 35B (FIG. 2), and operation signals coming from operation buttons provided to the front panel. Through such information and signal processing, the control substrate 5 exercises drive-control over the rear projector 1 (FIG. 1) including the liquid crystal panels 451 (FIG. 8) of the optical unit 4.

e. Configuration of Power Unit 6

The power unit 6 is a circuit board that converts alternating current coming from the outside into direct current, and supplies the drive power to the electronic components configuring the rear projector 1 (FIG. 1).

As shown in FIGS. 5 and 6, this power unit 6 is placed on the right side of the lower cabinet 3, and includes a power block 61, and a light source drive block 62. The power block 61 is connected with the power cable 35A (FIG. 2), and the light source drive block 62 is placed on the front side of the light source device housing member 471, and supplies the drive power to the light source lamp 411 (FIG. 8) configuring the light source device 41.

The power block 61 converts the commercial alternating current coming via the power cable 35A (FIG. 2) into direct current for supply to the electrical components such as the light source drive block 62 and the control substrate 5 after voltage control appropriately for the respective electronic components, i.e., increase or decrease the voltage.

The light source drive block 62 is a circuit board that rectifies and transforms the direct current provided by the power block 61 so that alternating current in the form of rectangular wave is generated. The resulting alternating current in the form of rectangular wave is provided to the light source lamp 411 (FIG. 8) of the light source device 41 so that the light source lamp 411 is illuminated. This light source drive block 62 is electrically connected to the control substrate 5, and this control substrate 5 exercises illumination control over the light source lamp 411 (FIG. 8) through the light source drive block 62.

f. Cooling System of Electro-optical Device 45

f-1. Cooling Configuration

FIG. 9 is a cross sectional overview of the rear projector 1 at substantially the center in the lateral direction.

As shown in FIG. 9, the lower cabinet 3 of the rear projector 1 is provided with a cooling fan 91, and ducts 92 and 93 to form a cooling path through which the air flows to cool the electro-optical device 45.

The cooling fan 91 is equivalent to a first circulation fan of the invention, and serves as a sirocco fan for ejecting the air sucked from the direction of a fan rotation axis to the direction of a rotation tangent. As shown in FIG. 9, the cooling fan 91 is placed below the horizontal portion 482 of the head member 48 that securely fixes the projection lens 46. An air intake surface 91A of the cooling fan 91 is facing the projection lens 46, and an air ejection surface 91B is facing the duct 92. With such a configuration, the cooling fan 91 sucks the air inside of the sealed upper cabinet 2 from the notch 212A formed to the bottom wall 212 of the upper cabinet 2, and ejects the sucked air into the duct 92.

The duct 92 is equivalent to a second duct of the invention, and is substantially L-shaped when viewed from the side. The duct 92 is attached below the horizontal portion 481 of the head member 48 onto which the electro-optical device 45 is placed and securely fixed.

This duct 92 is connected to the air ejection surface 91B of the cooling fan 91 at one end, and the other end is connected with the horizontal portion 481. With these duct 92 and horizontal portion 481, the air coming from the cooling fan 91 flows through the duct 92, and is directed from the lower portion to the liquid crystal panels 451, the light-enter-side polarizing plates 452, and the light-exit-side polarizing plates 453 of the electro-optical device 45 through the aperture section 481A formed to the horizontal portion 481.

With such a duct 92, the air coming from the cooling fan 91 is guided to the electro-optical device 45 without fail.

More in detail, by including such a duct 92 that one end is connected to the air ejection surface 91B of the cooling fan 91, and the other end is connected below to the electro-optical device 45 through the horizontal portion 481, the air coming from the cooling fan 91 reaches the electro-optical device 45 without air dispersion. What is more, with such a configuration that the air ejected from the cooling fan 91 flows through the duct 92, the air can be directed smoothly to the electro-optical device 45. As a result, the electro-optical device 45 is increased in the cooling efficiency.

The duct 93 is equivalent to a first duct of the invention, and guides the air used for cooling the electro-optical device 45 toward the rear side of the reflective mirror 2A. This duct 93 is a tubular member that is substantially S-shaped in the vertical cross section. As shown in FIGS. 5 and 9, the open upper portion of the duct 93 is attached to the bottom wall 212 of the upper cabinet 2, whereby substantially a rectangular space in lateral cross section is formed inside. The lower end portion of the duct 93 is connected with the duct connection member 49 that is provided at the position of the lid-like member 473 corresponding to the electro-optical device 45. The upper end portion thereof is connected to both the lower end of the reflective mirror 2A, and the lower end of the rear wall 211 of the upper cabinet 2. With such a duct 93, the air used for cooling the electro-optical device 45 first flows inside of the duct 93, and then flows into the interstice between the reflective mirror 92A and the rear wall 211.

f-2. Cooling Path

Described next is a path for the air cooling the electro-optical device 45, i.e., cooling path D.

As shown in FIG. 9, the air inside of the upper cabinet 2 is gathered closer to the air intake surface 91 of the cooling fan 91, and then is sucked as indicated by an arrow D1. Such air gathering and sucking is resulted from driving of the cooling fan 91 located in the lower cabinet 3. Thus sucked air is ejected from the air ejection surface 91B of the cooling fan 91, and flows inside of the duct 92 as indicated by an arrow D2. The air then is directed toward the electro-optical device 45 after going through the aperture section 481 A that is formed to the horizontal portion 481 of the head member 48 to which the duct 92 is connected.

The air thus directed to the electro-optical device 45 flows upward along the components provided on the color light basis, i.e., the liquid crystal panels 451, the light-enter-side polarizing plates 452, and the light-exit-side polarizing plates 453. More in detail, the air cools the components of the liquid crystal panels 451, the light-enter-side polarizing plates 452, and the light-exit-side polarizing plates 453 by flowing between the components, i.e., between the light-exit-side surface of the field lens 455 and the light-enter-side surface of the light-enter-side polarizing plate 452, between the light-exit-side surface of the light-enter-side polarizing plate 452 and the light-enter-side surface of the liquid crystal panel 451, between the light-exit-side surface of the liquid crystal panel 451 and the light-enter-side surface of the light-exit-side polarizing plate 453, and the light-exit-side surface of the light-exit-side polarizing plate 453 and the light-enter-side surface of the cross-dichroic prism 454.

After cooling the components of the liquid crystal panels 451, the light-enter-side polarizing plates 452, and the light-exit-side polarizing plates 453, the air goes still upward as indicated by an arrow D3. This is because the air is heated after cooling the components, and the discharge pressure from the cooling fan 91 helps. The air thus enters inside of the duct 93 through the aperture section 491 that is formed to the duct connection member 49 placed at the upper part of the electro-optical device 45.

As indicated by an arrow D4, the air thus entered inside of the duct 93 moves upward along the duct 93 and the bottom wall 212 of the upper cabinet 2, and then flows between the reflective mirror 2A and the rear wall 211.

As indicated by an arrow D5, the air flowing between the reflective mirror 2A and the rear wall 211 as such then moves upward along the formation direction of the reflective mirror 2A and the rear wall 211, and then reaches the upper end portion of the reflective mirror 2A. In the process of flowing along the reflective mirror 2A and the rear wall 211, the air heated after cooling the electro-optical device 45 is cooled down by coming in contact with the air in the upper cabinet 2, the reflective mirror 2A, and the rear wall 211 for heat radiation.

After reaching the upper end portion of the reflective mirror 2A, the air is cooled and thus weighed more, and as indicated by an arrow D6, moves downward along the screen 2B. The air is then sucked by the cooling fan 91 again for use for cooling the electro-optical device 45.

The path for the air cooling the electro-optical device 45 using the cooling fan 91 as such is formed inside of the sealed space S, which is configured by the upper cabinet 2 and the lower cabinet 3. That is, the sealed space S is substantially T-shaped when viewed from the front, including the space inside of the upper cabinet 2, the space from the upper cabinet 2 to the cooling fan 91, the space inside of the duct 92, the space around the electro-optical device 45, and the space inside of the duct 93. The space in the upper and lower cabinets 2 and 3 in which the air flows along the arrows D1 to D6 is sealed against the outside of the rear projector 1. Accordingly, the cooling path of the electro-optical device 45 is the path for the air circulating inside of the sealed space S.

As such, unlike the case of using the air guided from the outside of the rear projector 1, no dust in the air will attach the components of the liquid crystal panels 451, the light-enter-side polarizing plates 452, the light-exit-side polarizing plates 453, or others, configuring the electro-optical device 45 so that no image degradation occurs.

According to the rear projector 1 configured as such in the present embodiment, the following effects can be achieved.

With such a configuration that the path of the air circulating inside of the sealed space S is formed between the reflective mirror 2A and the rear wall 211 attached with the reflective mirror 2A, the path can be long enough to sufficiently cool, through heat radiation, the air that is heated after cooling the electro-optical device 45 configured to include the liquid crystal panels 451 or others.

More in detail, the reflective mirror 2A is of a large size compared with other components configuring the rear projector 1, and by the air flowing toward upward on the rear side of the reflective mirror 2A, the air flows long along the reflective mirror 2A. Such a configuration accordingly leads to the path that is long enough to sufficiently cool the heated air after cooling the electro-optical device 45, and thus even if the air to be directed to the electro-optical device 45 is the one circulated often in the space, the air can be sufficiently cool when directed to the electro-optical device 45.

As such, the cooling efficiency of the electro-optical device 45 can be increased, and the temperature can be low in the sealed space S.

After cooling the electro-optical device 45, the air flows on the rear side of the reflective mirror 2A.

Assuming if the air flows on the front side of the reflective mirror 2A, the air may go across the optical path of the luminous fluxes directed from the projection lens 46 toward the reflective mirror 2A. The air is considerably high in temperature after cooling the electro-optical device 45, and if such air goes across the optical path, image flicking may occur. In some cases, the images to be displayed on the screen 2B will be degraded.

Such concerns are cleared if the air is directed to flow on the rear side of the reflective mirror 2A after cooling the electro-optical device 45. With this being the case, image formation can be performed in a stable manner.

After cooling the electro-optical device 45, the air flows upward in the interstice formed between the reflective mirror 2A and the rear wall 211.

If such an air flow is disturbed and the air is resultantly dispersed inside of the sealed space S, the air circulation in the sealed space S is stopped so that the cooling efficiency is reduced for the air.

On the other hand, with such a configuration that the air is made flow upward after cooling the electro-optical device 45, the air flow directing upward is not disturbed and thus the air can be smoothly directed to between the reflective mirror 2A and the rear wall 211.

As a result, the air circulation can be kept good in the sealed space S, and thus the temperature is not increased that much in the sealed space S so that the electro-optical device 45 can be protected from temperature increase.

What is more, by including the duct 93 whose end is opened toward the electro-optical device 45, and the other end is opened toward between the reflective mirror 2A and the rear wall 211, the air can smoothly flow between the reflective mirror 2A and the rear wall 211 after cooling the electro-optical device 45. With such a configuration, the air can flow between the reflective mirror 2A and the rear wall 211 with no disturbance occurring to the flow path formed in the sealed space S, and with no air stagnation or dispersion.

As such, the air circulation can be better in the sealed space S, and the temperature can be reduced in the sealed space S so that the optical modulator can be improved in cooling efficiency.

### 2. Second Embodiment

Described next is a rear projector 1A according to a second embodiment of the present invention.

The rear projector 1A of the second embodiment is similar in configuration to the rear projector 1 of the above first embodiment, except that the sealed space S is formed therein with a cooling path for the polarizing beam splitter 423 configuring the optical unit 4. In the below, any components similar or substantially similar to those already described above are provided with the same reference numerals and not described again.

FIG. 10 is a vertical cross sectional overview of the rear projector 1A having the cross section at the position corresponding to the polarizing beam splitter 423. FIG. 11 is a schematic view of a cooling path of the polarizing beam splitter 423.

In the rear projector 1A of the present embodiment, a path E is formed in the sealed space S for the air cooling the polarizing beam splitter 423. As shown in FIGS. 10 and 11, this cooling path E is configured by ducts 94 and 96, and a cooling fan 95.

The duct 94 is equivalent to a third duct of the present embodiment, and is a tubular body that is substantially U-shaped in vertical cross section. As shown in FIG. 10, this duct 94 is connected with a notch 212C at one end, and the other end is connected with an aperture section 472D formed to the component housing member 472 configuring the optical unit 4. Herein, the notch 212C is the one formed at the position closer, i.e., rightward of FIG. 1, to the light source device 41 (FIG. 5) from the notch 212A (FIG. 9) formed to the bottom wall 212 of the upper cabinet 2.

The cooling fan 95 is equivalent to a second circulation fan of the invention, and as described above, is provided in such a manner as to cover the aperture section 473A formed at the position corresponding to the polarizing beam splitter 423 of the lid-shape member 473. This cooling fan 95 is so placed that the air intake surface is facing the polarizing beam splitter 423, and the air ejection surface is facing the duct 96.

With such a configuration, when the cooling fan 95 is driven, the air inside of the sealed space S is responsively directed toward the polarizing beam splitter 423 via the duct 94. In the course of this process, the air flows along the polarizing beam splitter 423 located on the air-intake side of the cooling fan 95 so that the air can be directed without fail to the polarizing beam splitter 423, which serves as an optical conversion device.

What is more, because the air intake surface of the cooling fan 95 is facing the polarizing beam splitter 423, the air in the sealed space S first flows through the duct 94, and then gathers closer to the polarizing beam splitter 423 located on the air-intake side of the cooling fan 95. This accordingly keeps the amount of air to be enough to cool the polarizing beam splitter 423 so that the polarizing beam splitter 423 can be increased in the cooling efficiency.

The duct 96 is connected to the air ejection surface of the cooling fan 95 at one end, and the other end is connected with a notch 212D that is formed closer to the upper rear of the polarizing beam splitter 423 on the bottom wall 212 of the upper cabinet 2. With such a configuration, the duct 96 is gently curved in the rear direction.

This duct 96 is provided for ejecting the air coming from the cooling fan 95 into the sealed space S of the upper cabinet 2. With such a duct 96, the air coming from the cooling fan 95 after cooling the polarizing beam splitter 423 is smoothly ejected into the sealed space S.

Described here is a path for the air cooling the polarizing beam splitter 423, i.e., cooling path E.

When the cooling fan 95 located above the polarizing beam splitter 423 is driven, the air in the sealed space S is responsively sucked by the cooling fan 95, and flows into the duct 94 via the notch 212C formed to the bottom wall 212 as indicated by an arrow E1 of FIG. 10. As indicated by an arrow E2, the air thus entered into the duct 94 then flows therein before flowing into the component housing member 472 through the aperture section 472D formed to the component housing member 472.

The air thus entered into the component housing member 472 moves upward along the polarizing beam splitter 423. More in detail, as shown in FIG. 11, the air flows between the components, i.e., between the light-exit-side surface of the second lens array 422 and the light-enter-side surface of the polarizing beam splitter 423, and between the light-exit-side surface of the polarizing beam splitter 423 and the light-enter-side surface of the superposition lens 424, and then moves upward while cooling the polarizing beam splitter 423.

After cooling the polarizing beam splitter 423, the air is heated and sucked by the cooling fan 95 via the aperture section 473A of the lid-like member 473, and then is ejected into the duct 96 by the cooling fan 95.

As indicated by an arrow E3 of FIG. 10, the air thus ejected into the duct 96 flows inside thereof before entering into the sealed space S. More in detail, because the duct 96 is curved in shape, the air is ejected into the vicinity of the reflective mirror 2A after passing through the duct 96.

At this time, because the air is heated and thus weighed less in the course of cooling the polarizing beam splitter 423, as indicated by an arrow E4, the air moves upward along the reflective surface on the front side of the reflective mirror 2A. In the course of flowing along the reflective mirror 2A as such, this air is subjected to heat exchange with the remaining air in the heated space S by coming in contact with the remaining air and the reflective mirror 2A so that the air is cooled. The heat of the air is radiated to the outside of the rear projector 1A by the air being in contact with the side walls 213 and 214 (FIG. 2) of the upper cabinet 2, or others.

As indicated by an arrow E5, the air flown along the reflective mirror 2A becomes heavier as it is cooled by heat exchange with the remaining air, and is then directed differently downward. As a result, the air in the sealed space S flows downward along the screen 2B. Thereafter, the air flowing along the screen 2B flows into the duct 94 again as indicated by the arrow E1, and is sucked by the cooling fan 95.

According to such a rear projector 1A of the second embodiment of the invention, the similar effects to the rear projector 1 of the above first embodiment can be achieved together with the following effects.

That is, with such a configuration that the path E for the air cooling the polarizing beam splitter 423 is formed separately from the cooling path D for the above-described electro-optical device 45, the polarizing beam splitter 423 can be increased in the cooling efficiency.

More in detail, when the cooling fan 95 is driven, the air in the sealed space S flows into the duct 94, and then flows inside of the component housing member 472. In this flow process, the air sucked by the cooling fan 95 flows along the polarizing beam splitter 423 in the component housing member 472 so that the polarizing beam splitter 423 is cooled. Thereafter, the air used for cooling the polarizing beam splitter 423 is ejected by the cooling fan 95 into the duct 96, and flows into the duct 94 again after cooled by flowing inside of the sealed space S. This thus allows to separately cool the polarizing beam splitter 423 in the course of circulating the air in the sealed space S, whereby the polarizing beam splitter 423 can be cooled with good efficiency.

The cooling fan 95 is so placed that the air intake surface faces the polarizing beam splitter 423. With such a configuration, after passing through the duct 94, the air can be gathered closer for air blowing to the polarizing beam splitter 423 located at the air-intake side of the cooling fan 95. With another configuration that the polarizing beam splitter 423 is located on the air-intake side of the cooling fan 95, the polarizing beam splitter 423 and therearound is kept low pressure so that the air of a predetermined wind pressure can be directed toward the polarizing beam splitter 423.

As such, the air can be directed to the polarizing beam splitter 423 without fail, and thus the polarizing beam splitter 423 can be increased in the cooling efficiency to a greater degree.

### 3. Third Embodiment

Described next is a rear projector according to a third embodiment of the invention.

The rear projector of the third embodiment is similar in configuration to the rear projector 1 of the above first embodiment, except that the cooling fan 91 directing the air to the electro-optical device 45 directs the air also to the polarizing beam splitter 423.

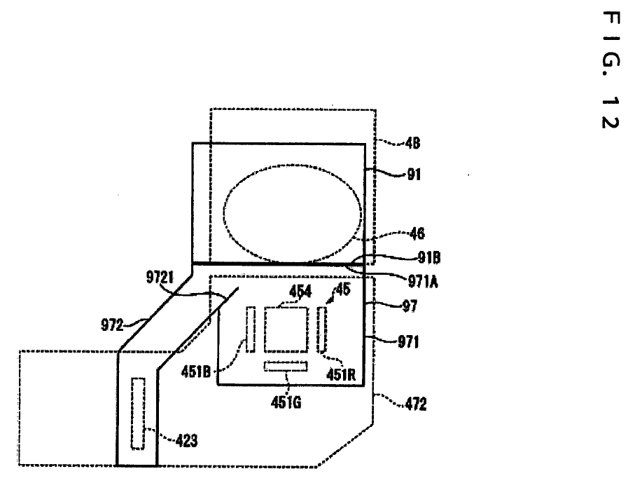

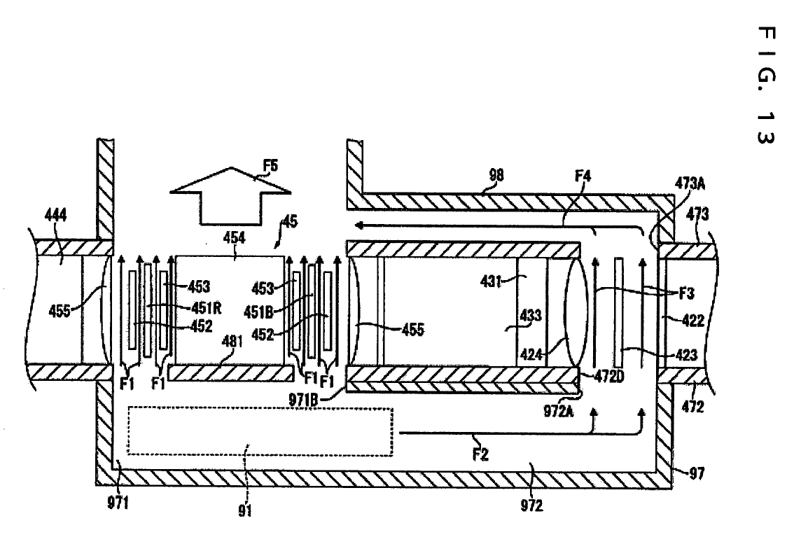

FIG. 12 is a plane overview schematically showing the electro-optical device 45 of the rear projector of the third embodiment, and a duct 97 that guides the cooled air to the polarizing beam splitter 423. FIG. 13 is a diagram schematically showing the cooling path for cooling the electro-optical device 45 and the polarizing beam splitter 423.

As shown in FIGS. 12 and 13, similarly to the rear projector 1 of the first embodiment, the rear projector of the present embodiment is provided with the cooling fan 91, and ducts 97 and 98, all of which are placed below the projection lens 46 (not shown in FIG. 13).

As shown in FIG. 12, the duct 97 is substantially rectangular in shape when viewed from above, and includes a first air guide section 971 to be connected to the cooling fan 91, and a second air guide section 972 that is so provided as to branch from the first air guide section 971. With such components, the duct 97 is substantially invert-J shaped when viewed from above.

The first air guide section 971 serves to guide the air coming from the cooling fan 91 to the electro-optical device 45, and is connected to both the air ejection surface 91B of the cooling fan 91, and the horizontal portion 481 of the head member 48 carrying thereon the electro-optical device 45. To the surface facing the air ejection surface 91 B of the cooling fan 91 of the first air guide section 971, an aperture 971A is formed to guide the air ejected from the cooling fan 91 into the first air guide section 971. Similarly, to the surface of the first air guide section 971 facing the horizontal portion 481 of the head member 48, i.e., the upper surface of the first air guide section 971, an aperture 971B (FIG. 13) is formed to guide the air flowing inside of the first air guide section 971 into the electro-optical device 45.

The second air guide section 972 serves to guide the air coming from the cooling fan 91 to the polarizing beam splitter 423. The second air guide section 972 is so formed as to extend from the side surface of the first air guide section 971 toward beneath the polarizing beam splitter 423, and is connected to the aperture 472D of the component housing member 472. At the connection portion between the first and second air guide sections 971 and 972, an air guide plate 9721 is provided to guide the air flowing into the first air guide section 971 into the second air guide section 972. The air guide plate 9721 is extending toward inside of the first air guide section 971. At the position corresponding to the polarizing beam splitter 423 of the second air guide section 972, an aperture 972A (FIG. 13) is formed to guide the air flowing into the second air guide section 972 into the polarizing beam splitter 423.

That is, such a duct 97 is provided to flow the air coming from the cooling fan 91, pro rata, to the electro-optical device 45 and the polarizing beam splitter 423.

The pro rata ratio herein is so set that the air for supply to the electro-optical device 45 is higher than the air for supply to the polarizing beam splitter 423 using the air guide plate 9721. This is surely not restrictive, and the ratio may be set as appropriate.

The duct 98 is substantially L-shaped when viewed from the side, and is attached onto the lid-like member 473 configuring the optical component cabinet 47 of the optical unit 4. As shown in FIG. 13, this duct 98 combines the air used for cooling the polarizing beam splitter 423 and that for the electro-optical device 45, and guides the combination result into the duct 93 (FIG. 9) to be attached to the bottom wall 212 of the upper cabinet 2. With such a configuration, the duct 98 is so placed that the bottom portion thereof crosses over the aperture section 473A and the upper portion of the electro-optical device 45 for connection with the lower end portion of the duct 93 at the upper portion of the electro-optical device 45. Here, the aperture 473A is the one formed at the position corresponding to the polarizing beam splitter 423 of the lid-like member 473. As a result, not only the air used for cooling the electro-optical device 45 but also the air used for cooling the polarizing beam splitter 423 circulate inside of the sealed space S after flowing through the duct 93 (FIG. 9).

In the below, described is a path for the air cooling the electro-optical device 45 and the polarizing beam splitter 423, i.e., cooling path F.

When the cooling fan 91 located below the projection lens 46 is driven, as indicated by an arrow D1 of FIG. 9, the air inside of the sealed space S is sucked by the cooling fan 91. As shown in FIGS. 12 and 13, the air is then ejected into the first air guide section 971 of the duct 97 from the cooling fan 91.

Here, the air ejected into the first air guide section 971 is split into two portions, pro rata, by the air guide plate 9721. As shown in FIG. 13, one portion of the resulting air flows inside of the first air guide section 971 toward beneath the electro-optical device 45, and from the aperture 971B, flows upward as indicated by an arrow F1. This air then flows along the electro-optical device 45 to cool the device 45. Thereafter, the air after cooling the electro-optical device 45 is heated in the course of cooling the electro-optical device 45, and moves upward as indicated by an arrow F5 by the discharge pressure from the cooling fan 91 before guided into the duct 93 (refer to FIG. 9).

As shown in FIG. 13, the other portion of the air ejected into the first air guide section 971 of the duct 97 and split by the air guide plate 9721 is guided in the direction indicated by the arrow F2. The air then flows inside of the second air guide section 972 before reaching in the vicinity of the aperture 472D of the component housing member 472 located below the polarizing beam splitter 423. Thereafter, as indicated by an arrow F3, the air flows upward along the polarizing beam splitter 423 after going through the aperture 972A of the second air guide section 972, and the aperture 472D of the component housing member 472 so that the polarizing beam splitter 423 is cooled.

As indicated by an arrow F4, the air heated after cooling the polarizing beam splitter 423 flows inside of the duct 98 via the aperture 473A formed at the position of the lid-like member 473 corresponding to the polarizing beam splitter 423. As indicated by an arrow F5, this air moves upward after combined together with the air used for cooling the electro-optical device 45, and then flows inside of the duct 93 (not shown in FIGS. 12 and 13).

Similarly to the air indicated by the arrows D4, D5, and D6 of FIG. 9, the air flown in the duct 93 circulates in the sealed space S. Thus circulated air is sucked and ejected by the cooling fan 91 again to be ready for cooling the electro-optical device 45 and the polarizing beam splitter 423.

According to such a rear projector of the third embodiment of the invention, the effects similar to the rear projector 1 of the above first embodiment can be achieved together with the following effects.

More specifically, the duct 97 splits the air, pro rata, coming from the cooling fan 91 for supply to the electro-optical device 45 and the polarizing beam splitter 423 so that a single piece of the cooling fan 91 can cool these components.

he air used for cooling the electro-optical device 45 is combined together with the air used for cooling the polarizing beam splitter 423 by flowing through the duct 93, and the resulting air circulates in the sealed space S through the duct 93. With such a configuration, the air used for cooling the electro-optical device 45 separately flows in the sealed space S without crossing the air used for cooling the polarizing beam splitter 423 so that the air circulation is improved in the sealed space S.

This thus prevents the air from stopping its flow in the sealed space S so that the efficient air circulation can be implemented, thereby allowing to cool the electro-optical device 45 and the polarizing beam splitter 423 with good efficiency.

### 4. Fourth Embodiment

While the preferred embodiments of the present invention have been described above in detail, the foregoing description is not restrictive. That is, although the invention has been described specifically for embodiments when taken in conjunction with the accompanying drawings, it is understood that numerous other modifications and variations can be devised for those embodiments in terms of shape, material, quantity, and any other detailed configurations by those skilled in the art without departing from the technical idea and the scope of the invention.

In view thereof, the description about the shape, material, or others is in all aspects illustrative for enhancing understanding of the invention and not restrictive. The description using component names with no or nearly no limitation on the shape, material, and others is included in the invention.

The above embodiments take the configuration that the air used for cooling the liquid crystal panels 451 serving as an optical modulator is guided to between the reflective mirror 2A and the rear wall 211 through the duct 93. This is surely not restrictive, and the air may be guided to between the reflective mirror 2A and the rear wall 211 by natural convection.

Further, the above embodiments take such a configuration that the air used for cooling the liquid crystal panels 451 flows upward between the reflective mirror 2A and the rear wall 211. Alternatively, the air may flow in the horizontal direction. That is, the air may flow into between the reflective mirror 2A and the rear wall 211 from either the side wall 213 or 214, and flow out from the other side wall 213 or 214. If this is the configuration that the air used for cooling the liquid crystal panels 451 flows upward, the air is heated and thus weighed lighter in the course of cooling the liquid crystal panels 451 so that the air path can be formed along such an air flow.

Still further, the above embodiments take such a configuration that the cooling fan 91 is placed below the projection lens 46. This is surely not restrictive, and the cooling fan 91 may be placed below or above any cooling objects such as the liquid crystal panels 451 and the polarizing beam splitter 423. That is, the position of the cooling fan is not an issue here as long as the air circulates in the sealed space S, and the air can be directed to the cooling objects.

Still further, the above embodiments take such a configuration that the air flows upward along the electro-optical device 45, specifically in the second and third embodiments, the air flows upward also along the polarizing beam splitter 423. This is surely not restrictive, and the air may flow along the horizontal direction of the cooling objects. If this is the configuration that the air flows upward, the air is heated after cooling the components and thus moves upward so that the smooth air flow can be derived.

In the second and third embodiments, the optical conversion device is exemplified by the polarizing beam splitter 423. This is surely not restrictive, and any other optical components will do as long as those are capable of optical conversion with respect to any incoming luminous fluxes. For example, a filter or others may be exemplified for such an optical conversion device that restricts transmission of light of a predetermined wavelength.

In the above embodiments, exemplified are the rear projectors 1 and 1A using three optical conversion devices. The number of the optical modulation devices is not restrictive, and the rear projector may use one, two, or four or more optical modulation devices. Moreover, exemplified is the liquid crystal panel 451 as an optical modulation device. This is not restrictive, and the optical modulation device may not be of liquid crystal such as devices using micro mirrors. What is more, the optical modulation device may not be of a transmittance type but of a reflective type.

Moreover, exemplified in the above embodiments is the configuration that the optical unit 4 is substantially L-shaped when viewed from above. This is not the only configuration, and the optical unit 4 may be substantially U-shaped when viewed from above.

The invention is suitably applied to a rear projector that includes an image formation device, a projection optical device, a reflective mirror, a screen, and a cabinet for housing such components. In such a rear projector, images formed by the image formation device are enlarged and projected onto the reflective mirror by the projection optical device, and thus projected images are reflected on the screen by the reflective mirror for image projection.

What is claimed is:

1. A rear projector, comprising:
a light source;
an optical modulator that modulates luminous fluxes emitted by the light source to form images based on image information;
an image formation device including a projection optical device that enlarges and projects the images formed by the optical modulator;
a reflective mirror that reflects the luminous fluxes as the images coming from the projection optical device;
a screen on which the luminous fluxes are projected after reflected by the reflective mirror;
a box cabinet that accommodates components of the rear projector, the box cabinet including a first cabinet section that accommodates the image formation device, and a second cabinet section that includes the screen and the reflective mirror;
the optical modulator being accommodated in a sealed space including a space of the second cabinet section; and
the second cabinet section including a first side surface on which the screen is provided, and a second side surface facing the first side surface and that has the reflective mirror arranged thereon so as to form an interstice between the reflective mirror and second side surface, the interstice being formed with a path through which air used for cooling the optical modulator circulates.

2. The rear projector according to claim 1, further comprising
a first duct that opens toward the optical modulator at one end, and that opens toward the interstice at another end, and that guides the air used for cooling the optical modulator toward the interstice.

3. The rear projector according to claim 1, further comprising;
a first circulation fan below the projection optical device to circulate the air in the sealed space; and
a second duct that opens toward an air ejection surface of the first circulation fan at one end, that opens toward the optical modulator at another end, and that guides the air ejected from the first circulation fan to the optical modulator.

4. The rear projector according to claim 1,
the image formation device including an optical conversion device that subjects the luminous fluxes to optical conversion, and an optical component cabinet that is set with an illumination optical axis for the luminous fluxes coming from the light source, and that is placed at a predetermined position on the illumination axis while housing the optical modulator;
the optical component cabinet being formed with an aperture that links inside and outside of the optical component cabinet at a position corresponding to the optical conversion device each on side surfaces facing each other;
one of the apertures being provided with a third duct that links inside of the optical component cabinet and the sealed space to guide the air in the sealed space to the optical converter; and
the other of the apertures being provided with a second circulation fan whose air intake surface is facing the optical conversion device, and that circulates the air in the sealed space.
